(19) United States
(12) Patent Application Publication
(10) Pub. No.: US 2009/0200217 A1
(43) Pub. Date: Aug. 13, 2009

(54) WATER PURIFICATION FILTER ASSEMBLY

(75) Inventor: Min-won Kim, Chungcheongbuk-do (KR)

Correspondence Address: EGBERT LAW OFFICES, 412 MAIN STREET, 7TH FLOOR, HOUSTON, TX, 77002, US

(73) Assignee: MICROFILTER CO., LTD., Chungcheongbuk-do (KR)

(21) Appl. No.: 12/299,460

(22) PCT Filed: Dec. 18, 2006
(86) PCT No.: PCT/KR2006/005518

§ 371 Date: Dec. 18, 2008

(30) Foreign Application Priority Data
Jun. 23, 2006 (KR) 10-2006-0056985

(51) Int. Cl. B01D 21/34

(52) U.S. Cl. 210/136

(57) ABSTRACT

A water purification filter assembly is disclosed. The water purification filter assembly of the present invention includes a manifold, which is provided in a water purifier, and a circular cap, which is provided under the manifold and has a slide slot, with a protrusion provided under the circular cap. The filter assembly further includes a filter cartridge which has a head part-coupled to the circular cap and has a filter part provided with a filter therein. The filter assembly further includes a fastening member, which fastens the head part of the filter cartridge to the circular cap, and a guide groove, into which the protrusion is inserted. The fastening member is formed in the upper surface of the filter part of the filter cartridge. Therefore, processes of coupling and removing the filter cartridge are made easy and convenient.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates, in general, to water purification filter assemblies and, more particularly, to a water purification filter assembly, which has a structure such that a filter cartridge is easily and removably coupled to a manifold, by which a filter is coupled to a water purifier.

2. Description of Related Art Including Information Disclosed Under 37 CFR 1.97 and 37 CFR 1.98.

Generally, water purifiers are water-purifying apparatuses, which remove foreign substances from drinking water, such as tap water or spring water, and supply the purified water. Such a water purifier includes a filter cartridge, which purifies water in a multistage manner.

The filter cartridge of the water purifier has an inlet port and an outlet port.

Furthermore, the filter cartridge selectively includes a preprocess water purification filter, a pre-carbon water purification filter, a membrane water purification filter, or a post-carbon water purification filter, depending on the intended purpose.

In addition, the filter cartridge of the water purifier includes a manifold, which has an inlet passage, through which water is drawn, and an outlet passage, through which water is discharged. A control valve, which controls the flow of water, is provided in the inlet passage.

As well, a circular cap, which has therein a cylindrical space that communicates with the inlet passage and the outlet passage, is provided under the lower end of the manifold. A slide slot is formed in the circumferential inner surface of the circular cap. The filter cartridge is installed in the cylindrical space of the circular cap by inserting a fastening member, which protrudes from the circumferential outer surface of an upper end of the filter cartridge, into the slide slot of the circular cap.

### BACKGROUND ART

As such, the filter cartridge is coupled to the manifold, thus forming a filter assembly. A representative example of such a filter assembly was proposed in Korean Patent Registration No. 521117, which was filed by the inventor of the present invention.

However, the conventional filter assembly has a problem related to the sliding of the fastening member of the filter cartridge to the slide slot of the circular cap.

In detail, in order to correctly insert the fastening member of the filter cartridge into the slide slot of the circular cap, a user must rotate the filter cartridge in several directions under the circular cap, such that the position of the filter cartridge is adjusted. Therefore, it takes a longer time to replace the filter cartridge with a new one.

Moreover, it is very difficult for an inexperienced user to replace the filter cartridge with a new one.

### BRIEF SUMMARY OF THE INVENTION

### Technical Problem

Accordingly, the present invention has been made keeping in mind the above problems occurring in the prior art, and an object of the present invention is to provide a water purification filter assembly which reduces the time that it takes to replace a filter cartridge with a new one, and makes it easy to replace the filter cartridge.

### Technical Solution

In order to accomplish the above object, the present invention provides a water purification filter assembly, including a manifold, having an inlet passage, through which water is drawn, an outlet passage, through which the water is discharged, and a control valve provided in the inlet passage to control flow of the water. A circular cap is provided under a lower end of the manifold, having therein a cylindrical space, the space communicating with the inlet passage and the outlet passage, and a slide slot formed in a circumferential inner surface of the circular cap, the slide slot having a slope part, with a protrusion provided under a lower end of the circular cap. A filter cartridge has a head part inserted into the cylindrical space in the circular cap, the head part having an inlet hole, into which the water is supplied from the inlet passage, an outlet port, through which the water is discharged into the outlet passage, and a filter part having a filter to purify the water. A fastening member is provided on the head part of the filter cartridge and inserted into the slide slot of the circular cap to fasten the filter cartridge to the circular cap. A guide groove is formed in an upper surface of the filter part of the filter cartridge in a curved shape, so that the protrusion of the circular cap is inserted into the guide groove such that rotation of the filter cartridge is guided by the protrusion.

### Advantageous Effects

In the water purification filter assembly of the present invention having the above-mentioned construction, a protrusion, which is provided on the lower end of a circular cap, is seated into a guide groove of a filter cartridge. Thus, when the filter cartridge is rotated, because the protrusion is guided by the guide groove, a fastening member of the filter cartridge can be easily inserted into the slide slot of the circular cap. Therefore, the time required to replace the filter cartridge with a new one is reduced. Furthermore, there is an advantage in that even an inexperienced user can replace the filter cartridge with a new one.

### BRIEF DESCRIPTION OF THE SEVERAL VIEWS OF THE DRAWINGS

FIG. 1 is an exploded perspective view of a water purification filter assembly, according to an embodiment of the present invention.

FIG. 2 is a perspective view showing part of the water purification filter assembly according to the embodiment of the present invention.

FIG. 3 is a sectional view of FIG. 2.

FIG. 4 is a bottom exploded perspective view of FIG. 2.

### DESCRIPTION OF THE ELEMENTS IN THE DRAWINGS

100: manifold
110: inlet passage
111: control valve
111a: protrusion tip
120: outlet passage
200: cap
210: cylindrical space
220: slide slot
221: slope part
230: protrusion
240: curved surface part
300: filter cartridge
310: head part
320: filter part
311: inlet hole
312: outlet port
313: fastening member
313a: inclined surface
320: filter part
321: handle
330: guide groove

### DETAILED DESCRIPTION OF THE INVENTION

Hereinafter, a water purification filter assembly according to a preferred embodiment of the present invention will be described in detail with reference to the attached drawings. In the drawings, the thicknesses of lines or the sizes of elements maybe exaggerated to more clearly and conveniently illustrate the present invention. Furthermore, the terms used will be defined in consideration of their functions in the present invention, and thus the definition of these terms may be changed depending on the intention or practice of a user or operator. Therefore, the definitions of the terms must be determined based on the entire content of the specification.

In addition, the following embodiment is only an illustrative example facilitating understanding of the present invention, and does not limit the scope and spirit of the present invention. Therefore, those skilled in the art will appreciate that various modifications, additions and substitutions based on the technical spirit of the present invention are possible.

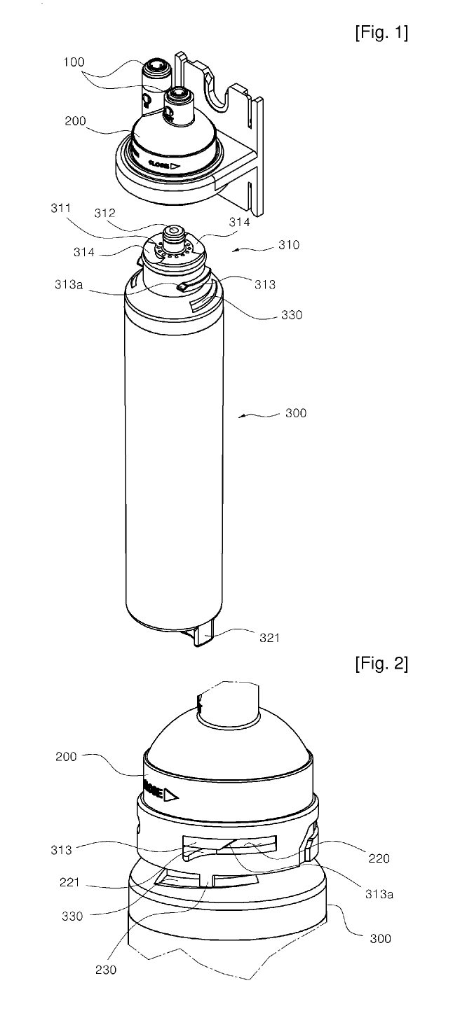

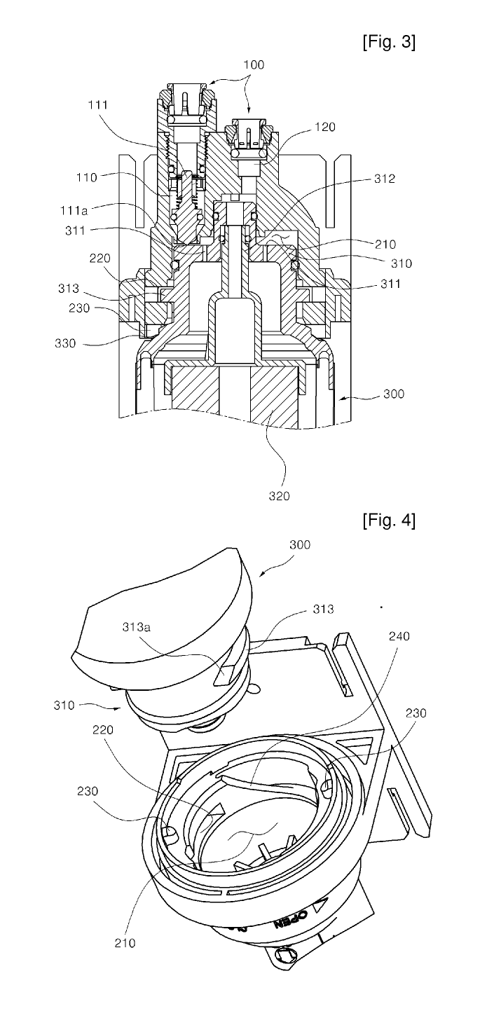

FIG. 1 is an exploded perspective view of a water purification filter assembly according to an embodiment of the present invention. FIG. 2 is a perspective view showing part of the water purification filter assembly according to the embodiment of the present invention. FIG. 3 is a sectional view of FIG. 2. FIG. 4 is a bottom exploded perspective view of FIG. 2.

As shown in the drawings, the water purification filter assembly according to the embodiment of the present invention includes a manifold 100, which is mounted to a water purifier, and a circular cap 200, which is provided under the lower end of the manifold 100, has slide slots 220 therein, and has protrusions 230 on a lower end thereof. The water purification filter assembly further includes a filter cartridge 300, which has a head part 310, coupled to the circular cap 200, and has a filter part 320, in which a filter is installed. The water purification filter assembly further includes fastening members 313, which are provided on the head part 310 to couple the filter cartridge 300 to the circular cap 200, and guide grooves 330, which are formed in the upper surface of the filter part 320 so that the protrusions 230 of the circular cap 200 are inserted into the respective guide grooves 330.

Here, the manifold 100 has therein an inlet passage 110, through which water is drawn, and an outlet passage 120, through which the water is discharged. A control valve 111, which controls the flow of water, is provided in the inlet passage 110.

The circular cap 200 is provided under the lower end of the manifold 100. A cylindrical space 210, which communicates with the inlet passage 110 and the outlet passage 120, is formed in the circular cap 200. Furthermore, the slide slots 220, each of which has a slope part 221 to smoothly guide the associated fastening member 13, is formed in the circumferential inner surface of the circular cap 200. The protrusions 230 are provided under the lower end of the circular cap 200.

The filter cartridge 300 is inserted into the cylindrical space 210 of the circular cap 200. The filter cartridge 300 includes the head part 310, which has therein inlet holes 311, through which water is supplied from the inlet passage 110, and has an outlet port 312, through which water is discharged to the outlet passage 120. The filter cartridge 300 further includes the filter part 320, which has therein the filter for purifying water.

Here, the fastening members 313 protrude at diametrically opposite positions from the circumferential outer surface of the head part 310 of the filter cartridge 300. The fastening members 313 are inserted into the respective slide slots 220 of the circular cap 200, thus fastening the filter cartridge 300 to the circular cap 200.

Furthermore, the guide grooves 330 are formed in curved lines in the upper surface of the filter part 320 of the filter cartridge 300, so that the protrusions 230 of the circular cap 200 are inserted into the respective guide grooves 330. The guide grooves 330 are shaped such that the rotation of the filter cartridge 300 is guided by the protrusions 230.

Here, the guide grooves 330 are preferably formed at diametrically opposite positions in the upper surface of the filter cartridge 300. When the head part 310 of the filter cartridge 300 is inserted into the cylindrical space in the circular cap 200, the protrusions 230, which are provided under the lower end of the circular cap 200, are disposed in right ends of the respective guide grooves 330 to have an arrangement such that the guide grooves 330 protrude to the left from the left ends of the respective slide slots 220.

That is, because the protrusions 230 are inserted into respective guide grooves 330 before the fastening members 313 are inserted into and locked in respective slide slots 220, when the filter cartridge 300 is rotated in a counterclockwise direction, the protrusions 230 slide to the left along the respective guide grooves 330 under the guidance of the guide grooves 330, and the fastening members 313 are rotated in counterclockwise directions and are thus inserted into respective slide slots 220. As a result, the fastening members 313 are locked in respective slide slots 220.

Here, each fastening member 313 has on a right end thereof an inclined surface 313a such that the fastening member 313 can easily enter and slide along the associated slide slot 220. Furthermore, each fastening member 313 also has on a left end thereof an inclined surface 313a such that the fastening member 313 can be easily removed from the associated slide slot 220.

Furthermore, a curved groove 314, which compresses the control valve 111 of the manifold 100 to open the control valve 111 when the filter cartridge is rotated, is formed in a perimeter portion of the upper surface of the head part 310. The curved groove 314 is reduced in depth in the direction in which the curved groove 314 compresses the control valve 111 upwards. Thus, the curved groove 314 serves as a cam having a shape such that it gradually compresses the control valve 111 upwards.

Here, a protrusion tip 111a is provided under the lower end of the control valve 111 to reduce the contact area between the control valve 111 and the curved groove 314. In other words, the protrusion tip 111a is brought into contact with and is compressed by the surface defining the curved groove 314. Here, the protrusion tip 111a serves to reduce frictional force generated by contact between the control valve 111 and the curved groove 314 when the head part 310 is rotated by rotation of the filter cartridge 300, thus facilitating the rotation of the filter cartridge 300, and preventing the control valve 111 from being deformed by frictional force.

At this time, the fastening members 313 provided on the head part 310 of the filter cartridge 300 are inserted into and locked to the respective slide slots 220 of the circular cap 200, thus fastening the filter cartridge 300 to the circular cap 200. During the process of fastening the filter cartridge 300 to the circular cap 200, the control valve 111, which is provided in the inlet passage 110 of the manifold 100, is moved upwards, so that the inlet passage 110 is opened. Thereby, water is supplied into the inlet holes 311 of the filter cartridge 300 through the inlet passage 110. The water, which has been supplied into the inlet holes 311, is purified by the filter and is thereafter discharged into the outlet passage 120 of the manifold 100 through the outlet port 312.

Meanwhile, the inlet holes 311 of the head part 310 are several circular holes, which are formed around the outlet port 312 in a circular arrangement. Thus, when the filter cartridge 300 is rotated in a clockwise direction for replacement of the filter cartridge 300 with a new one, so that the fastening members 313 of the head part 310 are removed from respective slide slots 220 and the filter cartridge 300 is thereby removed from the circular cap 200, water, which is present in the filter cartridge 300, is prevented from being abruptly discharged outside.

In other words, while the filter cartridge 300 is fastened to the circular cap 200, water is forcibly supplied to the filter cartridge 300 by the pump of the water purifier, and thus this water applies predetermined pressure to the interior of the filter cartridge 300. Therefore, when the filter cartridge 300 is removed from the circular cap 200, water, which has been in the filter cartridge 300, is discharged to the outside through the inlet holes 311 of the filter cartridge 300. Here, in the present invention, because the inlet holes 311, each of which has the shape of a relatively small circular hole, are arranged in a circle, the water is prevented from being rapidly discharged through the inlet holes 311.

In addition, a handle 321 for rotation of the filter cartridge 300 is provided under the lower surface of the filter part 320, which is concave, thus making it easy for the user to rotate the filter cartridge using the handle 321. The head part 320 of the filter cartridge 300 can be easily removed from the circular cap 200 by holding and rotating the handle 321.

Meanwhile, the slide slots 220 of the circular cap 200 are connected to respective curved surface parts 240, which are brought into contact with the respective fastening members 313 and are provided on the circumferential inner surface of the circular cap 200 to have downwardly inclined shapes such that the fastening members 313 are guided towards the lower end of the circular cap 200. The inclined surfaces 313a, which correspond to curved surface parts 240, are provided in the respective fastening members 313.

Here, the fastening members 313 are removed from the respective slide slots 220 by rotating the filter cartridge 300 in a counterclockwise direction. At this time, because the slide slots 220 are connected to the respective curved surface parts 220, the fastening members 313 can smoothly slide in directions in which the respective curved surface parts 220 are inclined.

That is, the filter cartridge 300 receives the pressure of water supplied into the inlet holes 311, so that the head part 310 is biased by the pressure of water in the direction in which the head part 310 is separated from the circular cap 20. Therefore, the fastening members 313, which have been removed from the respective slide slots 220 by the rotation of the filter cartridge 300, can be easily moved along the curved surface parts 240 by the pressure of water. Therefore, the filter cartridge 300 can be easily separated from the circular cap 200.

1. A water purification filter assembly, comprising:
a manifold, having an inlet passage, through which water is drawn, an outlet passage, through which the water is discharged, and a control valve provided in said inlet passage to control flow of the water;
a circular cap provided under a lower end of the manifold and having therein a cylindrical space in communication with the inlet passage and the outlet passage, and a slide slot formed in a circumferential inner surface of said circular cap, the slide slot having a slope part; with a protrusion provided under a lower end of the circular cap;
a filter cartridge, comprising a head part inserted into the cylindrical space in the circular cap, said head part having an inlet hole, into which the water is supplied from the inlet passage, and an outlet port, through which the water is discharged into the outlet passage;
a filter part having a filter to purify the water;
a fastening member provided on the head part of the filter cartridge and inserted into the slide slot of the circular cap to fasten the filter cartridge to the circular cap; and
a guide groove formed in an upper surface of the filter part of the filter cartridge in a curved shape, so that the protrusion of the circular cap is inserted into the guide groove such that rotation of the filter cartridge is guided by the protrusion.

2. The water purification filter assembly according to claim 1, wherein said inlet hole of the head part comprises a plurality of circular holes provided around said outlet port in a circular arrangement.

3. The water purification filter assembly according to claim 1, wherein said filter part has a concave lower surface with a handle for rotation of said filter cartridge.

4. The water purification filter assembly according to claim 1, further comprising:
a curved groove formed in a perimeter portion of an upper surface of said head part, said curved groove compressing said control valve of said manifold to open the control valve when the head part is rotated and reducing in depth in a direction in which the curved groove compresses the control valve.

5. The water purification filter assembly according to claim 4, further comprising:
a protrusion tip provided on a lower end of said control valve, reducing a contact area between said control valve and said curved groove of said head part.

6. The water purification filter assembly according to claim 1, wherein said slide slot of the circular cap is connected to a curved surface part, being in contact with the fastening member and provided on the circumferential inner surface of the circular cap to have a downwardly inclined shape, said fastening member being guided towards the lower end of the circular cap and having an inclined surface corresponding to the curved surface part provided thereon.
